(19) United States
(12) Patent Application Publication
(10) Pub. No.: US 2025/0315619 A1
(43) Pub. Date: Oct. 9, 2025

(54) NARRATIVE GENERATION PLATFORM FOR EXPLAINABLE PREDICTIVE CLASSIFIER

(71) Applicant: FAIR ISAAC CORPORATION, Minneapolis, MN (US)

(72) Inventors: Scott Michael Zoldi, San Diego, CA (US); Joseph Francis Murray, San Diego, CA (US)

(21) Appl. No.: 18/629,583

(22) Filed: Apr. 8, 2024

(51) Int. Cl. G06F 40/284

(52) U.S. Cl. CPC G06F 40/284

(57) ABSTRACT

A computer-implemented method, comprising: selecting, from a list of available functions by one or more processors, a function based on an output of a predicative classifier; retrieving, by the one or more processors, a dataset relevant to the selected function, wherein the dataset is a time series dataset; analyzing, in accordance with the selected function by a calculation engine, the dataset to derive temporal information and quantitative information associated with the dataset; and generating, by the one or more processors, a narrative for the output of the predicative classifier based on the temporal information and the quantitative information.

### TECHNICAL FIELD

The subject matter described herein relates to systems and methods for using Machine Learning (ML) techniques to generate narratives describing data, predictions, and outputs of explainable classifiers.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes and mitigating potential risks. These examples illustrate the substantial impact of predictive ML models, transforming industries and driving data-driven decision-making across diverse sectors.

There are cases where providing explanations for classifier outputs becomes essential or, in some instances, required, due to, for example, regulatory requirements. Moreover, these explanations can offer valuable insights for further model development in various scenarios. For example, legal authorities may demand a detailed account of why a particular transaction was flagged as suspicious to ensure that the decision-making process adheres to, for example, anti-money laundering laws. Similarly, financial institutions may use these explanations to refine their predictive models. In many situations, the explanations alone may not suffice the regulatory requirements, as a narrative regarding what event(s) contributes to the outcome generated by the classifiers may be required. Regulatory bodies, such as those enforcing the General Data Protection Regulation (GDPR) in Europe, mandate that decisions made by automated systems, especially those that have a legal or similarly significant effect on individuals, be accompanied by meaningful information about the logic involved. This is where the narrative is required for compliance. There exists a need for a narrative generation platform that can articulate the decision-making reasoning and/or process of predictive classifiers in a manner that satisfies these regulatory stipulations.

### SUMMARY

Methods, systems, and articles of manufacture, including computer program products, are provided for generating ML classifier for data owners. In one aspect, there is provided a computer-implemented method, comprising selecting, from a list of available functions by one or more processors, a function based on an output of a predicative classifier; retrieving, by the one or more processors, a dataset relevant to the selected function, wherein the dataset is a time series dataset; analyzing, in accordance with the selected function by a calculation engine, the dataset to derive temporal information and quantitative information associated with the dataset; and generating, by the one or more processors, a narrative for the output of the predictive classifier based on the temporal information and the quantitative information.

In some variations, the output of the predictive classifier comprising reason codes and a list of relevant data entries, wherein the retrieved dataset comprises the list of relevant data entries.

In some variations, the narrative is a human-readable text describing one particular data entry of the list of relevant data entries.

In some variations, the narrative is a human-readable text summarizing the list of data entries in accordance with the temporal information and the quantitative information.

In some variations, the narrative comprises a human-readable text indicating a degree of abnormality based on comparing a data entry of the dataset against population-wide and cluster-wide statistics.

In some variations, the population-wide and cluster-wide statistics comprise quantiles, minimum, and maximum of quantities of interests.

In some variations, the method further comprises refining the narrative based on user feedback.

In some variations, the output of the predictive classifier and the retrieved dataset are converted, by the one or more processor, into a standardized token format suitable for natural language processing (NLP).

In some variations, the method further comprises determining, by the one or more processor, which function of the calculation engine to execute based on reason codes associated with the predictive classifier output, wherein the reason codes indicate an explanation of the predictive classifier output associated with the dataset; executing, by the calculation engine, by the one or more processors, the determined functions to generate additional textual features that are indicative of the explanation indicated by the reason codes; and integrating, by the one or more processors, the additional textual features into the narrative to provide a more detailed explanation of the predictive classifier's output in relation to the dataset.

In another aspect, there is provided a computer program product including a non-transitory computer readable medium storing instructions. The operations include selecting, from a list of available functions by one or more processors, a function based on an output of a predicative classifier; retrieving, by the one or more processors, a dataset relevant to the selected function, wherein the dataset is a time series dataset; analyzing, in accordance with the selected function by a calculation engine, the dataset to derive temporal information and quantitative information associated with the dataset; and generating, by the one or more processors, a narrative for the output of the predictive classifier based on the temporal information and the quantitative information.

In another aspect, there is provided a system comprising: a programmable processor; and a non-transient machine-readable medium storing instructions that, when executed by the processor, cause the at least one programmable processor to perform operations comprising: selecting, from a list of available functions by one or more processors, a function based on an output of a predicative classifier; retrieving, by the one or more processors, a dataset relevant to the selected function, wherein the dataset is a time series dataset; analyzing, in accordance with the selected function by a calculation engine, the dataset to derive temporal information and quantitative information associated with the dataset; and generating, by the one or more processors, a narrative for the output of the predictive classifier based on the temporal information and the quantitative information.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of a narrative generation platform for predictive classifiers, in accordance with one or more embodiments of the current subject matter.

FIG. 2 is a diagram illustrating an example of a subset of a narrative generation platform for predictive classifiers, in accordance with one or more embodiments of the current subject matter.

FIG. 3 is a diagram illustrating a flow chat of a process 300 for generating an narrative for an output of a predictive classifier and associated input data, in accordance with one or more embodiments of the current subject matter.

FIG. 4 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, narratives for the outcomes of predictive classifiers may be instrumental in balancing between complex data-driven decisions and the requirements for transparency and understandability. These narratives serve to provide a clear and coherent reasoning behind the predictions generated by classifiers. This is particularly valuable in sectors where the rationale for decisions is subject to scrutiny, such as finance, healthcare, and criminal justice. The subject matter described herein may provide comprehensive narratives for the outputs/outcomes of predictive classifiers.

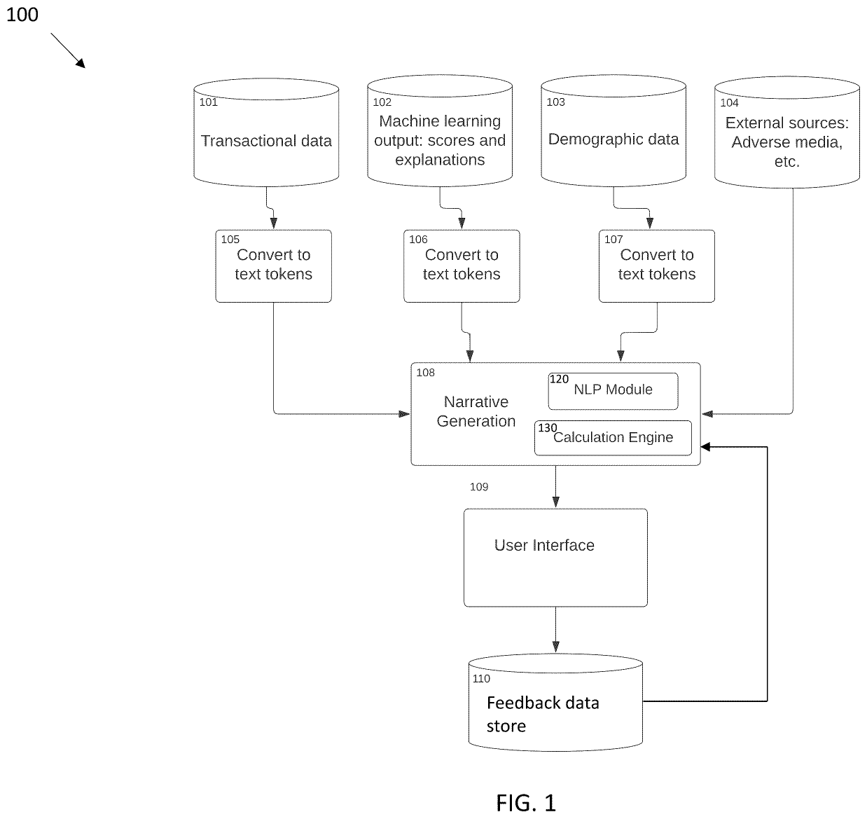

FIG. 1 is a diagram illustrating an example of a narrative generation platform for predictive classifiers, in accordance with one or more embodiments of the current subject matter. As shown in FIG. 1, the narrative generation platform 100 may comprise a narrative generation module 108. Optionally, the narrative generation platform 100 may comprise transactional data storage 101, machine learning output storage 102, demographic data storage 103, and/or a external sources data storage 104. In some embodiments, the narrative generation platform 100 may merely receive data from various sources without having to store the data in the storages 101, 102, 103, and 104. In other words, the narrative generation platform 100 may not include the storages 101, 102, 103, and 104. The transactional data may include original transaction information logs from one or more entities, such as bank accounts, credit card accounts, or lines of credit, which detail the financial activities conducted over a period of time. These logs can encompass a variety of transaction types, including but not limited to purchases, withdrawals, deposits, and transfers, each potentially annotated with metadata like transaction amounts, dates, merchant categories, and geographic locations. The transaction data may be converted by the token conversion module 105 into a standardized token format. Initially, the structured transaction data, which may be in formats such as CSV or JSON, is transformed into natural language text strings. These text strings are then further processed into a sequence of integers representing word-parts or tokens, which are amenable to input to the Natural Language Processing (NLP) module 120 of the narrative generation module 108. The machine learning output data may include predictions and/or explanations from machine learning classifiers. In some embodiments, predictions may take the form of a probability of each type of suspicious/criminal activity on each account. Explanations from these predictive machine learning classifiers are often in the form of a discrete set of reason codes, with associated text-based descriptions. All of these are converted from a structured format (such as JSON or CSV) into a natural language text format by the token conversion module 106. The demographic information may include information such as the age, gender, occupation, and income level of the account holder, as well as the date the account was opened, the type of account (e.g., business or personal), and the stated purpose for the account, which can provide context for understanding transaction patterns and identifying deviations from expected behavior. The external sources data stored in storage 104 or received from another entity may include adverse media reports, prior customer interactions with the financial institution, demographic information, and additional contextual information relevant to the customer or account, which can be used to adjust the narrative and provide a more comprehensive view of the entity's behavior. As shown in FIG. 1, the transactional data, the machine learning output data, the demographic data, and the data from external sources may collectively referred to as input data to the narrative generation module 108. In some embodiments, the input data may be converted by token conversion modules 105, 106, and 107 into a standardized token format. Initially, the structured transaction data, which may be in formats such as CSV or JSON, is transformed into natural language text strings. These text strings are then further processed into a sequence of integers representing word-parts or tokens, which are amenable to input to the NLP module 120 of the narrative generation module 108. As shown in FIG. 1, some type(s) of input data may readily in the format that is amenable to input to the NLP module 120, for example, external sources data such as media data.

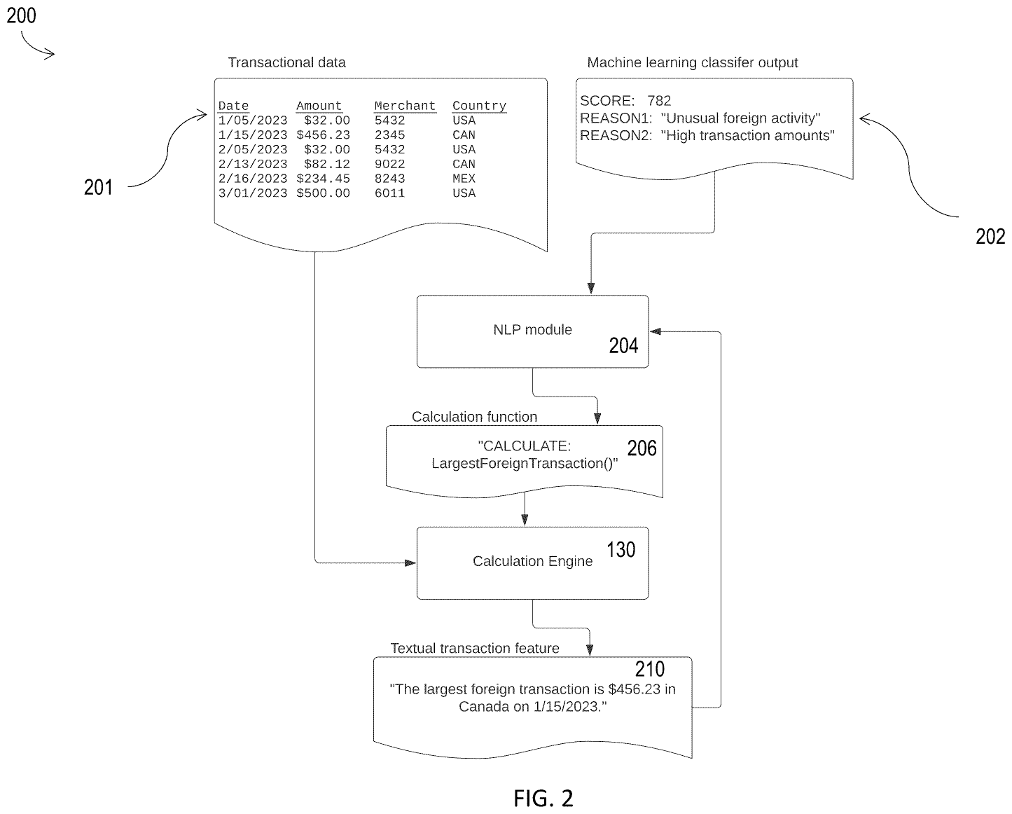

The NLP module 120 may process the standardized tokens derived from the various data inputs, including transactional data, machine learning classifier outputs, the demographic data, and external sources data, to generate a concise and coherent narrative. This narrative is designed to be easily understood by human investigators and may include explanations for the predictive classifier's output, summaries of transactional behavior, and any other relevant information that aids in the decision-making process or regulatory compliance. The NLP module may utilize advanced techniques such as deep learning, context-aware language models, and entity recognition to generate accurate, relevant narratives. As shown in FIG. 1, the narrative generation module 108 further comprises a calculation engine 130. The operations and mechanisms of the calculation engine 130 are described in detail with reference to FIG. 2.

FIG. 2 is a diagram illustrating an example of a subset of a narrative generation platform for predictive classifiers, in accordance with one or more embodiments of the current subject matter. As shown in FIG. 2, the transaction data 201 may be in a structured format, such as CSV or JSON, and may represent time-series data, which includes timestamps for data entries. This time-series data is typically used to track the occurrence times of transactions over a period, providing insights into patterns and trends within the data. In some embodiments, the time-series transactional data may include a sequence of data entries indexed in time order. This time-series data is typically used to track the sequence of transactions over a period. As shown in FIG. 2, the machine learning classifier output 202 may include predictions and/or explanations from machine learning classifiers. In some embodiments, predictions may take the form of a probability of each type of suspicious/criminal activity on each account. In some embodiments, predictions may take the form of a score of suspicious/criminal activity on the monitored account. For example, the output entry 202 as shown in FIG. 2 may include a prediction score of 782. Explanations from these predictive machine learning classifiers are often in the form of a discrete set of reason codes, with associated text-based descriptions. For example, the output entry 202 as shown in FIG. 2 may include two reason codes as explanations; reason 1 being “unusual foreign activity” and reason 2 being “high transaction amounts”.

As shown in FIG. 2, the classifier output 202 may be transmitted to NLP module 204, wherein the NLP module 204 may parse and/or analyze the output to identify the reason codes for the prediction. In some embodiments, the calculation engine 130 may have a set of functions that are available for calculating based an entity's transaction history. For example, a list of available functions may include, but not limited to:
NumberOfTransactions
NumberOfCashTransactions
NumberOfElectronicPayments
NumberOfForeignTransactions
DayWithMostTransactions
LargestAmount
LargestCashAmount
LargestElectronicPayment
LargestForeignTransaction
AverageTransactionAmount
MostFrequentMerchant

In some embodiments, the NLP module 204 may make the determination regarding which function(s) to select/call. In some embodiments, the NLP module 204 may determine which function(s) to select/call based on the reason code(s) received from the output of the predictive classifier. For example, if the reason codes indicate a high probability of fraudulent activity, the NLP module 204 may call functions such as LargestAmount, NumberOfCashTransactions, or DayWithMostTransactions to identify large, irregular transactions or sequences of transactions that deviate from the customer's typical behavior. In another example, if the reason codes suggest a pattern of foreign transactions that are unusual for the customer's history, the NLP module 204 may call (i.e., select) functions like NumberOfForeignTransactions and LargestForeignTransaction to provide detailed insights into these transactions.

The calculation engine 130 may retrieve a dataset relevant to the selected function. In some embodiments, the dataset may be one or more transactional data entries that are relevant to the selected function. For example, if the selected function is NumberOfForeignTransactions, then the calculation engine 130 may retrieve all transactions that have been classified as foreign based on criteria such as the location of the merchant, currency used, or transaction codes that indicate a cross-border transaction. The calculation engine 130 may then count the number of these foreign transactions to provide the quantitative data requested by the NLP module 204. In some embodiments, the calculation engine 130 may analyze the retrieved dataset in accordance with the selected function, and may derive temporal information and quantitative information associated with the dataset. In some embodiments, the derived temporal information may include date and time stamps, frequency and sequence of transactions, periods of high activity, trends over time, seasonality, and duration between transactions. Additionally, the calculation engine 130 may derive quantitative information including transaction amounts, total volume of transactions, average transaction amount, transaction count, statistical percentiles, variability or standard deviation, maximum and minimum transaction values, and cumulative value of transactions. Alternatively or additionally, the narrative generation module 108 as shown in FIG. 1 may generate the narrative(s) factoring in the results from the calculation engine 130, such as temporal information and the quantitative information. For example, a narrative may be “the largest foreign transaction is $456.23 in Canada on Jan. 15, 2023.”

In some embodiments, the calculation engine 130 may retrieve a dataset that is related to the reason code(s) of the output of the predictive classifier. In some embodiments, the retrieved dataset may include a list of data entries. In some embodiments, the narratives generated by the system may highlight or pinpoint to a particular data entry that is deemed most relevant or that singularly triggered the output. For instance, if the reason code indicates a high probability of fraudulent activity, the narrative may focus on a transaction within the dataset that has an unusually high value or an atypical transaction pattern, thereby driving an improved and concise explanation for the predictive classifier's output. For example, the narrative may describe an event on July 15th, where a transaction of $5,000 occurred at an electronics store, which is notably higher than the customer's average transaction amount of $150 and is inconsistent with their usual spending pattern, suggesting possible fraud. Alternatively or additionally, the narratives generated by the system may summarize the list of data entries in accordance with the temporal information and the quantitative information. For example, the narrative may provide an overview of the transaction patterns over the last quarter, highlighting a consistent increase in transaction volume that correlates with the reason codes for potential money laundering activities identified by the predictive classifier.

In some embodiments, the output of the calculation engine 130 is a termed a textual transaction feature, and is a natural language description and result of the call to the calculation engine 130. The textual transaction feature is understandable to human investigators, and can also be fed back into subsequent calls of the NLP module 204. In some embodiments, the calculation function selection/calling may follow the rules below. For example, certain calculations may always be called for every investigated entity, and these results presented in every narrative generated. This may ensure that the initial narrative generated has substantial accurate details of the entity's history. In some embodiments, as a function of other information, such as the separate predictive machine learning model reasons codes, demographic information, adverse media, the NLP module 204 may request specific data (e.g., temporal information, quantitative information) from the calculation engine 130, which can then be included in the narrative. For example, if the reason codes indicate unusual international activity, the NLP module may request the computation of the function of LargestForeignTransaction.

In some embodiments, the calculation engine 130 may calculate population-wide statistics, and compare those statistics against the entity of interest for the current narrative. For example, the function TransactionAmountPercentile can be used to find statistics for normal (e.g. between 25^{th} and 75^{th} % amounts) or extreme amounts (e.g. greater than 99^{th} %). Similarly to the population-wide statistics, the calculation engine 130 may compute statistics based on a peer group or clustering of similar entities. For example, the function Foreign TransactionAmountPercentileNearestCluster can find the amount statistics for entities in the most similar clustering to compare the customer narrative to a group of peers, i.e., measuring the cluster-wide statistics. This may provide a more contextualized analysis, allowing investigators to understand how an entity's behavior compares with that of a broader population or a specific subset of similar entities, thereby enhancing the relevance and accuracy of the narrative generated. In some embodiments, these population-wide and cluster-wide statistics may be calculated in a batch mode, estimated in a streaming fashion, or be provided from historical data. In some embodiments, for certain ML models, clustering may be estimated by measuring distances in a learned latent parameter space. Alternatively or additionally, clustering may be assigned through a hyper-personalization scheme to segment customers according to business logic.

In some embodiments, one data entry may be compared against the relevant or entire population, so to provide a degree of abnormality associated with this transaction. Alternatively or additionally, one data entry may be compared against the cluster-wide statistics to generate the degree of abnormality. In some embodiments, the human-readable narratives may include this degree of abnormality. For example, a transaction that is markedly higher than the 75th percentile of transaction amounts within a peer group could be flagged in the narrative as “significantly above typical activity levels,” thereby indicating a potential risk or anomaly. In another example, the degree of abnormality may be spelled out in the narratives, indicating not just the presence of an anomaly but also quantifying it, such as stating “this transaction is in the top 5% of all transactions for this account type,” which provides a clear statistical context for the investigator or reviewer. This comparative analysis enhances the narrative by providing context and highlighting deviations from established patterns, which can be beneficial in guiding further investigation or regulatory reporting.

In some embodiments, the population-wide and cluster-wide statistics may include quantiles, minimum, and maximum of quantities of interests. For example, the system may calculate the 25th, 50th (median), and 75th percentile values for transaction amounts within a given population or cluster to identify typical and atypical transaction behaviors. The minimum and maximum values can also be determined to highlight the range of transaction activities and to flag any transactions that are outliers, potentially indicating fraudulent or anomalous behavior. For example, the system may identify a transaction amount that exceeds the 95th percentile value within a cluster of similar accounts, which could suggest that the transaction is unusually large compared to the account holder's peers. This information can be incorporated into the narrative as a point of interest, such as “The transaction amount of $5000 is notably higher than the typical transaction range for similar accounts, exceeding the 95th percentile, and may warrant further investigation for potential irregularities.” Similarly, if a transaction amount is below the 5th percentile, the narrative might highlight this as “The transaction amount of $5 is exceptionally low for this type of account, falling below the 5th percentile, and could indicate testing of account security measures.” These statistical insights provide valuable context for the narrative, allowing for a more nuanced understanding of the transaction data. In some embodiments, the system may be configured to generate a narrative for a specific entity either automatically for the riskiest or most abnormal entities, or on-demand as needed by the human investigator. In either case, the data from an entity flows from the transactional data storage (e.g., module 101 in FIG. 1) to the text token generation module (e.g., module 105 in FIG. 1). As shown in FIG. 1, the machine learning score and explanations stored in the data storage (e.g., module 102 in FIG. 1), may also be tokenized through the conversion module (e.g., module 106 in FIG. 1). As discussed, the conversion modules (e.g., modules 105, 106, and 107 in FIG. 1) may first convert the structure data received from the data store(s) into a natural language text string, which is then converted to a string of integers representing word-parts, which is amenable to input to the narrative generation NLP module 120.

As shown in FIG. 1, in some embodiments, the narrative generation platform 100 may comprise a user interface 109 for user feedback. In some embodiments, the user feedback may include investigator feedback. The user interface 109 may allow collecting human-edited narrative text and then transmit the human-edited narrative text to the data store 110 for storage. In some embodiments, some entities may be determined to not need further investigation, and so no further human editing will occur, and for these, feedback tagging may be limited to fields such as “useful/not useful”, “accurate/inaccurate”, the user experience level, etc. These tags may be used in the training process to further refine the generation of narratives. In some embodiments, investigators may request additional calculations to be included in the narrative based on their review of the findings. In some embodiments, these requests may be posed in natural language and the NLP module 120 may format the request to the calculation engine 130. The user may interact with the initial generated narrative, requesting in natural language for further computations or comparisons. Therefore, the system may perform both an initial calculation and further refinements, where the NLP module 120 generates calls to the calculation engine 130.

In some embodiments, the NLP module 120 may be pre-trained on suitable type and quantity of text documents. In some embodiments, these text documents do not include specific examples of the desired transaction narratives. In some embodiments, the NLP module 120 may include a neural network model which models its input data through a statistical learning process. To improve the quality of the generated narratives, in some embodiments, the NLP module 120 may be additionally trained on the generated narratives and the appropriate user-feedback and expert correction. As shown in FIG. 1, the user feedback may be fed, via a feedback loop, to the narrative generation module 108, which may include the NLP module 120. In some embodiments, the training data (e.g., user feedback data) may be review and approved by user(s) with certain authority before allowing it to be used for training. The narrative generation platform 100 may include an audit log of which users contributed to which narrative in the training data. This audit log allows the inclusion or removal of narratives from the training set based on specific users, user experience level, or other properties in the audit log. In some embodiments, the training process may be performed locally to a specific financial institution, or be done at a centralized location. The local training may be necessary in some regulatory environments to keep sensitive data within restricted geographic or political regions.

In some experiments, the results are about 86.4% accurate. A set of generative narratives are presented below:

### Example 1

1. The majority of the transactions are purchases, with a few pre-authorizations.
2. The transactions are spread across multiple days, with the majority taking place on November 11th and 12th.
3. The transaction amounts vary widely, with some transactions being very small (e.g., $1.00) and others being much larger (e.g., $105.65).
4. The Fraud Score, which is a measure of the likelihood of fraud, is relatively low for most transactions, with a maximum value of 451.
5. All of the transactions have been approved, which suggests that they have not been flagged as potentially fraudulent by the bank's fraud detection system.

Note: The system is drawing attention to a large number of transactions occurring during November 11 and 12.

### Example 2

1. The majority of the transactions are for purchases of digital goods, with a few transactions for book stores, computer software stores, and hobby shops.
2. The transaction amounts vary widely, with some transactions in the range of $10.74, while others are in the range of $300.00 or more.
3. The majority of the transactions have a Fraud Score of 646 or lower, indicating a low risk of fraud. However, there are a few transactions with a Fraud Score of 706 or higher, indicating a higher risk of fraud.
4. All of the transactions have been approved, with no declined transactions.
5. The transactions are spread out over several days, with the first transaction occurring on November 15th and the last transaction occurring on November 30th.

Noted that item 4 in this example 2 is inaccurate (as there were in fact 3 declined transactions in the input), and it may be corrected by the information generated by calculation engine 130. This may be done by cross-referencing the transaction approval statuses derived from the dataset with the actual transaction records to identify any discrepancies. The output of the calculation engine 130 can then be used to update the narrative to reflect the accurate number of approved and declined transactions, ensuring the integrity and reliability of the information presented to the investigators.

### Example 3

1. The transactions before the highest Fraud Score (2022 Jun. 19) show a mix of grocery, eating places, and discount store purchases, with a few transactions in the 500-600 range.
2. The transactions after the highest Fraud Score (2022 Jun. 22) show a higher concentration of discount store purchases, with several transactions in the 200-300 range.
3. The transactions also show a higher average transaction amount compared to the transactions before the highest Fraud Score.

Note: In this example, the system compares transactions before and after the highest Fraud Score transaction and shows distinct differences in spending between the periods.

### Example 4

1. The majority of transactions before the highest Fraud Score were purchases at grocery stores (Schnuck Markets) and fast food restaurants (Steak n Shake, Arby's).
2. The highest Fraud Score transaction was a purchase at a utility company (Ameren) with a score of 451.
3. The majority of transactions after the highest Fraud Score were purchases at fast food restaurants (McDonald's), gas stations (Casey's General Store), and record stores (iTunes).
4. The transactions before the highest Fraud Score were mostly for small amounts (less than $50) and had low Fraud Scores (less than 100).
5. The transactions after the highest Fraud Score were mostly for small amounts (less than $50) and had low Fraud Scores (less than 100), similar to the transactions before the highest Fraud Score.

Note: In this example, the system compares transactions before and after the highest Fraud Score transaction, and reports the similarities between those events, which may represent that the legitimate cardholder is doing purchases after the fraud event.

### Example 5

1. Highest Fraud Score: The Fraud Score of 971 is the highest among all transactions in the table, indicating a very high likelihood of fraud.
2. Large amount: The transaction amount of $206.0 is significantly higher than the average transaction amount in the table, which could be a red flag for fraudulent activity.
3. Declined authorization: The authorization decision for this transaction is “declined,” which suggests that the cardholder's bank may have flagged the transaction as potentially fraudulent.
4. Cash transaction: The transaction type is “cash,” which could indicate that the cardholder is trying to hide their spending habits or make it more difficult to track their transactions.
5. Merchant category code: The merchant category code (4829) is for wires, money orders, and other financial services, which could be a red flag for fraudulent activity.

Note: In this example, the system was asked to compare the highest scoring transaction to the others. This shows solid extracted details related to the probable fraud scenarios.

### Example 6

1. The Summary Statistics section states that the maximum Fraud Score is 847, which occurred on Jun. 11, 2022, at 8:00 AM. The total number of transactions is 41, and the largest foreign transaction is $129.39. The 25th percentile amount for this card is $10.65, and the 75th percentile amount is $107.30. The most frequent merchant is Spotify USA, visited 10 times.
2. The highest Fraud Score transaction stands out because it has a much higher Fraud Score than the rest of the transactions, and it is also the largest transaction. Additionally, it is a purchase at a candy store, which is different from the other transactions, which are mostly purchases at Spotify USA.
3. Before the highest Fraud Score, the types of merchants visited include grocery stores, fast food restaurants, pet shops, drug stores, and veterinary services. These are all everyday necessity merchants.
4. After the highest Fraud Score, the types of merchants visited include Spotify USA, a barber and beauty shop, and a candy store. These are all discretionary spending merchants.

Note: In this example, the system highlights the suspicious high valued transaction at a likely fraudulent merchant given that it's the largest transaction amount in the history.

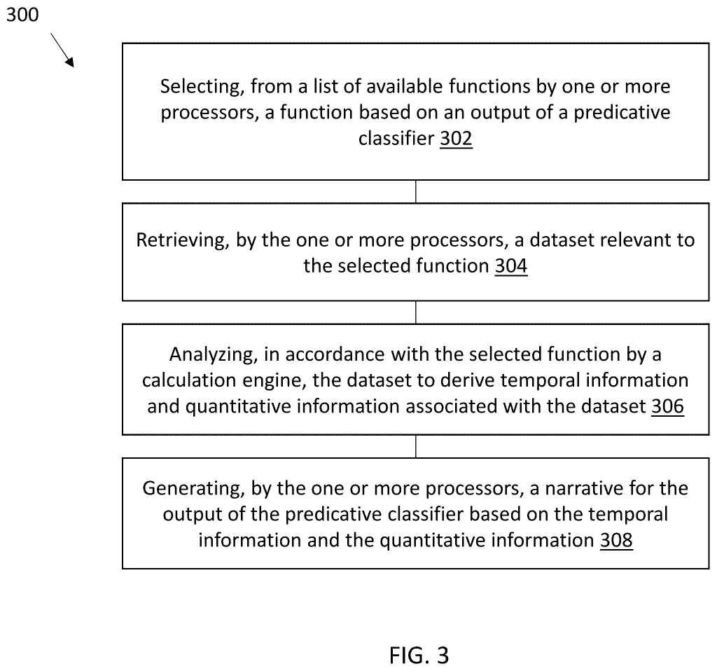

FIG. 3 is a diagram illustrating a flow chart of a process 300 for generating a narrative for an output of a predictive classifier, in accordance with one or more embodiments of the current subject matter. As shown in FIG. 3, the process 300 may begin with operation 302, wherein the system may select, from a list of available functions by one or more processors, a function based on an output of a predictive classifier. As discussed herein elsewhere, the output may include reason code(s) and a predictive result (e.g., score, probability, or binary result). In some embodiments, the platform may select one or more functions based on the reason code. Next, the process 300 may proceed to operation 302, wherein the system may retrieve a dataset that is relevant to the selected function. In some embodiments, the dataset is a time-series dataset. In some embodiments, this dataset may include a list of data entries that are relevant to the output of the predictive classifier. In some embodiments, this dataset may include a list of data entries that are relevant to perform the selected function. Next, in an operation 306, the platform may analyze the dataset to derive temporal information and quantitative information. In some embodiments, this analysis is performed in accordance with the selected function. Next, the process 300 may proceed to operation 308, wherein the narrative generation platform may generate a narrative for the output based on the temporal information and/or the quantitative information. In some embodiments, the population-wide and cluster-wide statistics may also be utilized to generate the narrative.

In some embodiments, the reason codes may be utilized to determine which function of the calculation engine to execute. In some embodiments, the calculation engine 130 may execute the determined function to generate additional textual features that are indicative of the explanation indicated by the reason codes. The additional textual features may be incorporated into the narrative to provide a more detailed explanation of the predictive classifier's output in relation to the dataset.

### Use Case 1

A healthcare provider employs the approach discussed herein, and the narrative generation platform to analyze patient data and identify potential health risks or diseases. The system's predictive classifier has flagged a patient's electronic health record (EHR) for a possible diagnosis based on recent lab results, symptoms logged, and historical health data. For example, the predictive classifier outputs a diagnostic report suggesting the patient may have Type 2 Diabetes Mellitus. The report includes reason codes that point to elevated blood glucose levels, increased body mass index (BMI), and a family history of diabetes. A brief explanation accompanying the diagnostic output indicates that the patient's lab results show consistent hyperglycemia, and the patient's weight and family history increase the risk of Type 2 Diabetes Mellitus. These factors, combined with the patient's age and sedentary lifestyle, contribute to the classifier's output. Upon receiving the diagnostic output, the narrative generation platform may proceed to generate a narrative. For example, the narrative may be:
1. Lab results over the past three months show blood glucose levels consistently above the normal range, with fasting glucose readings averaging 130 mg/dL.
2. The patient's BMI is currently at 32, which is classified as obese and is a known risk factor for Type 2 Diabetes Mellitus.
3. A review of the patient's family medical history reveals a pattern of diabetes, with both parents having been diagnosed with the condition in their late 40s.
4. Population-wide statistics indicate that the patient's glucose levels are in the 85th percentile compared to a demographically similar cohort, suggesting higher than average risk.
5. Cluster-wide statistics, based on a group of patients with similar BMI and age, show that the patient's glucose levels are in the 90th percentile within this group, further supporting the classifier's diagnosis.

The generated narrative provides a concise, human-readable summary of the patient's health data, emphasizing the lab results, personal and family medical history, and relevant population and cluster-wide statistics. This narrative may aid healthcare professionals in quickly grasping the patient's condition and determining the next steps for confirmation of the diagnosis and potential treatment plans. Additionally, this narrative may facilitate regulation compliance, such as adhering to the Health Insurance Portability and Accountability Act (HIPAA) by ensuring patient data confidentiality during the analysis process, and meeting the requirements of the General Data Protection Regulation (GDPR) by providing transparent and understandable explanations for automated decision-making systems used in patient care.

### Use Case 2

The systems and platform described herein may be utilized in the pharmaceutical industry. The development of a new drug involves a complex and data-intensive process. Researchers and developers deal with vast amounts of structured and unstructured data, including clinical trial results, patient demographics, adverse event reports, and regulatory compliance documents. A system that can automatically generate human-readable narratives from this data would be beneficial, particularly in explaining the outcomes of predictive models used for drug efficacy and safety predictions.

The input data to the system may include: 1. Clinical trial data, including patient responses, dosages, and outcomes. 2. Demographic information about trial participants. 3. Predictions and explanations from machine learning classifiers regarding drug efficacy and potential adverse events. 4. Regulatory documents and guidelines relevant to the drug development process. These types of input data are provided for explanatory purposes only, and it is well-understood that other types of input data may be utilized. The system for automatic generation of narratives in the context of new drug development based on the subject matter described herein may include: data stores for the clinical trial information, machine learning predictions, demographic data, and regulatory documents; 2. A token conversion module to standardize the various inputs into a token format suitable for NLP processing; 3. An NLP module to generate concise narratives summarizing the clinical trial data and the predictive model's outputs; 4. A calculation engine to provide specific quantitative information about the clinical trial data, such as statistical analysis results; and 5. A feedback system to collect and refine narratives based on user feedback from researchers, clinicians, and regulatory experts. Utilizing the system herein, a narrative may be generated. For example, the narrative could be:
In the recent Phase III clinical trial for Drug X, a total of 1,200 participants were enrolled, with a median age of 50. The trial spanned over 12 months, with participants receiving varying dosages of Drug X. The predictive classifier, utilizing a machine learning algorithm, indicated a 75% probability of Drug X being effective in reducing symptoms of the targeted condition, with a confidence interval of 70-80%. Notably, the 25th percentile of patient improvement scores exceeded the median improvement score of the placebo group, suggesting a statistically meaningful effect of the drug.
Adverse events were reported in 5% of the participants, which is below the expected range based on the demographic profile of the patient population. The maximum severity score of adverse events was 3 on a scale of 1 to 5, with no life-threatening events recorded. The narrative highlights that the adverse event frequency for Drug X is within the 40th percentile compared to similar drugs in the same therapeutic category, indicating a favorable safety profile.
The system's calculation engine also identified that the average dosage for the top quartile of responders was 10% lower than the overall trial average, which could suggest a potential for dose optimization.
Based on the analysis, Drug X shows promise in terms of efficacy and safety, with the data supporting further investigation into lower dosage strategies.

The narrative generated will assist in the preparation of regulatory submission documents, ensuring that the findings are communicated effectively and in compliance with regulatory standards for human-readable explanations.

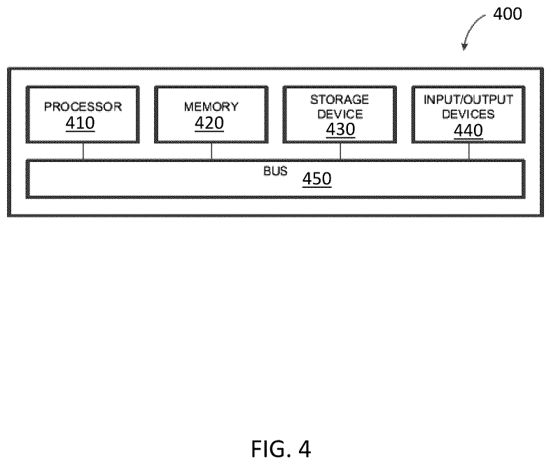

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
selecting, from a list of available functions by one or more processors, a function based on an output of a predicative classifier;
retrieving, by the one or more processors, a dataset relevant to the selected function, wherein the dataset is a time series dataset;
analyzing, in accordance with the selected function by a calculation engine, the dataset to derive temporal information and quantitative information associated with the dataset; and
generating, by the one or more processors, a narrative for the output of the predictive classifier based on the temporal information and the quantitative information.

2. The method of claim 1, wherein the output of the predictive classifier comprising reason codes and a list of relevant data entries, wherein the retrieved dataset comprises the list of relevant data entries.

3. The method of claim 2, wherein the narrative is a human-readable text describing one particular data entry of the list of relevant data entries.

4. The method of claim 2, wherein the narrative is a human-readable text summarizing the list of data entries in accordance with the temporal information and the quantitative information.

5. The method of claim 1, wherein the narrative comprises a human-readable text indicating a degree of abnormality based on comparing a data entry of the dataset against population-wide and cluster-wide statistics.

6. The method of claim 5, wherein the population-wide and cluster-wide statistics comprise quantiles, minimum, and maximum of quantities of interests.

7. The method of claim 1, further comprising, refining the narrative based on user feedback.

8. The method of claim 1, wherein the output of the predictive classifier and the retrieved dataset are converted, by the one or more processor, into a standardized token format suitable for natural language processing (NLP).

9. The method of claim 1, further comprising:
determining, by the one or more processor, which function of the calculation engine to execute based on reason codes associated with the predictive classifier output, wherein the reason codes indicate an explanation of the predictive classifier output associated with the dataset;
executing, by the calculation engine, by the one or more processors, the determined functions to generate additional textual features that are indicative of the explanation indicated by the reason codes; and
integrating, by the one or more processors, the additional textual features into the narrative to provide a more detailed explanation of the predictive classifier's output in relation to the dataset.

10. A computer program product comprising a non-transient machine-readable medium storing instructions that, when executed by at least one programmable processor, cause the at least one programmable processor to perform operations comprising:
selecting, from a list of available functions by one or more processors, a function based on an output of a predicative classifier;
retrieving, by the one or more processors, a dataset relevant to the selected function, wherein the dataset is a time series dataset;
analyzing, in accordance with the selected function by a calculation engine, the dataset to derive temporal information and quantitative information associated with the dataset; and
generating, by the one or more processors, a narrative for the output of the predictive classifier based on the temporal information and the quantitative information.

11. The computer program product of claim 10, wherein the output of the predictive classifier comprising reason codes and a list of relevant data entries, wherein the retrieved dataset comprises the list of relevant data entries.

12. The computer program product of claim 11, wherein the narrative is a human-readable text describing one particular data entry of the list of relevant data entries.

13. The computer program product of claim 11, wherein the narrative is a human-readable text summarizing the list of data entries in accordance with the temporal information and the quantitative information.

14. The computer program product of claim 10, wherein the operations further comprise:
determining, by the one or more processor, which function of the calculation engine to execute based on reason codes associated with the predictive classifier output, wherein the reason codes indicate an explanation of the predictive classifier output associated with the dataset;
executing, by the calculation engine, by the one or more processors, the determined functions to generate additional textual features that are indicative of the explanation indicated by the reason codes; and
integrating, by the one or more processors, the additional textual features into the narrative to provide a more detailed explanation of the predictive classifier's output in relation to the dataset.

15. A system comprising:
a programmable processor; and
a non-transient machine-readable medium storing instructions that, when executed by the processor, cause the at least one programmable processor to perform operations comprising:
selecting, from a list of available functions by one or more processors, a function based on an output of a predicative classifier;
retrieving, by the one or more processors, a dataset relevant to the selected function, wherein the dataset is a time series dataset;
analyzing, in accordance with the selected function by a calculation engine, the dataset to derive temporal information and quantitative information associated with the dataset; and
generating, by the one or more processors, a narrative for the output of the predictive classifier based on the temporal information and the quantitative information.

16. The system of claim 15, wherein the output of the predictive classifier comprising reason codes and a list of relevant data entries, wherein the retrieved dataset comprises the list of relevant data entries.

17. The system of claim 16, wherein the narrative is a human-readable text describing one particular data entry of the list of relevant data entries.

18. The system of claim 16, wherein the narrative is a human-readable text summarizing the list of data entries in accordance with the temporal information and the quantitative information.

19. The system of claim 15, wherein the output of the predictive classifier and the retrieved dataset are converted, by the one or more processor, into a standardized token format suitable for natural language processing (NLP).

20. The system of claim 15, wherein the operations further comprise:
determining, by the one or more processor, which function of the calculation engine to execute based on reason codes associated with the predictive classifier output, wherein the reason codes indicate an explanation of the predictive classifier output associated with the dataset;
executing, by the calculation engine, by the one or more processors, the determined functions to generate additional textual features that are indicative of the explanation indicated by the reason codes; and
integrating, by the one or more processors, the additional textual features into the narrative to provide a more detailed explanation of the predictive classifier's output in relation to the dataset.
